(19) United States
(12) Patent Application Publication
(10) Pub. No.: US 2025/0268281 A1
(43) Pub. Date: Aug. 28, 2025

(54) PET FOOD ADDITIVE

(71) Applicant: DMK Deutsches Milchkontor GmbH, Zeven (DE)

(72) Inventors: Sven-Rainer DÖRING, Zeven (DE); Marco STEFFENS, Elsdorf (DE)

(21) Appl. No.: 19/059,455

(22) Filed: Feb. 21, 2025

(30) Foreign Application Priority Data
Feb. 23, 2024 (DE) 24159373.0

(51) Int. Cl. A23K 20/163; A23K 10/20; A23K 20/105; A23K 20/111; A23K 20/126; A23K 20/147; A23K 20/20

(52) U.S. Cl. CPC A23K 20/163; A23K 10/20; A23K 20/105; A23K 20/111; A23K 20/126; A23K 20/147; A23K 20/20

(57) ABSTRACT

Proposed is an animal feed additive comprising or consisting of:
(a) glucose;
(b) galactose;
(c) lactose;
(d) minerals derived from milk, preferably from cow's milk;
(c) proteins derived from milk, preferably from cow's milk;
(f) organic acids; and
(g) water,
   where component (c) is optional.

### FIELD OF THE INVENTION

The present invention relates to an animal feed additive, its production process and its use, in particular as a molasses substitute, in the provision of animal feed.

### TECHNOLOGICAL BACKGROUND

Molasses is produced during sugar production from sugar beet. It is a sweet, dark, syrupy liquid (50% sugar) that remains after the sugar has crystallized. Traditionally, molasses is used as a tasty, energy-rich feed additive in agriculture. In many cases, molasses is mixed with conventional dry feed by the farmers themselves. However, molasses is a highly viscous substance which also tends to solidify in winter due to the low temperatures, making it considerably more difficult for the farmer to prepare the animal feed. In addition, molasses is not liked by all animals as a flavor enhancer. There is therefore a need for a substitute for molasses that is less viscous and has better taste properties.

Furthermore, in the dairy industry, the production of waste products or streams, which often contain a high content of minerals and sugar (lactose), is a known problem, as it is not always possible to process and reuse these waste products or streams. There is therefore great interest, not only economically but also in the interests of environmental protection, in finding an application for the above-mentioned waste products or streams generated by the dairy industry so that they can be further processed and “recycled”, so to speak.

### TASK OF THE INVENTION

The object of the present invention has therefore been to provide a composition which can be used as a molasses substitute in the manufacture of animal feed, so that the viscosity, in particular the solidification in the cold, as well as the taste problems associated with the use of molasses can be solved. Furthermore, this composition should be producible from one of the above-mentioned waste products or streams generated by the dairy industry.

### DESCRIPTION OF THE INVENTION

A first object of the invention relates to a composition, in particular an animal feed additive, comprising or consisting of
(a) glucose;
(b) galactose;
(c) lactose;
(d) minerals derived from milk, preferably from cow's milk;
(e) proteins derived from milk, preferably from cow's milk;
(f) organic acids; and
(g) water,
   where component (c) is optional.

Surprisingly, it was found that the composition according to the invention completely fulfills the extensive task described at the beginning. In fact, it was found that the composition according to the invention (animal feed additive) not only has a lower viscosity than molasses, which facilitates the preparation of the animal feed by mixing it with dry feed, but also that the animal feed containing the composition according to the invention (animal feed additive) enjoys significantly greater acceptance by the animals than the same animal feed containing molasses. In addition, the composition according to the invention (animal feed additive) shows a significantly lower tendency to solidify at low temperatures than molasses.

### Animal Feed Additive

In a preferred embodiment, the animal feed additive according to the invention comprises or consists of:
(a) about 20 to about 40 wt.-percent glucose;
(b) about 20 to about 40 wt.-percent galactose;
(c) 0 to about 40 wt.-percent lactose;
(d) about 1 to about 10 wt.-percent minerals derived from milk;
(d) about 1 to about 10 wt.-percent minerals derived from milk; and
(e) about 1 to about 7 wt.-percent organic acids;
   with the proviso that all quantities add up to 100 wt.-percent with water.
   The above-mentioned percentages by weight refer to the total weight of the animal feed additive according to the invention.

In a further preferred embodiment, the animal feed additive according to the invention comprises or consists of:
(a) about 25 to about 35 wt.-percent glucose;
(b) about 25 to about 35 wt.-percent galactose;
(c) 0 to about 30 wt.-percent lactose;
(d) about 2 to about 4 wt.-percent minerals derived from milk;
(d) about 2 to about 4 wt.-percent proteins derived from milk;
(c) about 3 to about 5 wt.-percent organic acids;
   with the proviso that all quantities add up to 100 wt.-percent with water.
   The above-mentioned weight percentages refer to the total weight of the animal feed additive according to the invention. For the avoidance of doubt, it is pointed out that the present application does not cover amounts which are less or more than 100 wt.-percent complementary. The skilled person is further able to select from the present disclosure such compositions with respect to their amounts of components (a) to (c) which together add up to 100 wt.-percent without having to engage in inventive step.

As stated above, the animal feed additive according to the invention contains organic acids which ensure that the animal feed additive according to the invention is microbiologically flawless and also does not spoil. In a preferred embodiment, the organic acid is selected from the group consisting of tartaric acid, malic acid, shikimic acid, lactic acid, acetic acid, citric acid, ascorbic acid, formic acid, succinic acid and fumaric acid or mixtures thereof, preferably from the group consisting of tartaric acid, malic acid, lactic acid, acetic acid, citric acid, ascorbic acid, or mixtures thereof, more preferably from the group consisting of tartaric acid, malic acid, lactic acid, citric acid, ascorbic acid, or mixtures thereof. In a particularly preferred embodiment, the organic acid is lactic acid.

As explained above, the animal feed additive according to the invention contains minerals derived from milk. These minerals are well known to the person skilled in the art and therefore need not be explained further. However, they are preferably minerals which are permeable to an ultrafiltration membrane having a pore diameter in the range of about 3,000 to about 50,000 and preferably about 5,000 to about 25,000 Daltons.

As explained above, the animal feed additive according to the invention contains proteins derived from milk. These proteins are well known to the person skilled in the art and therefore need not be explained further. However, they are preferably proteins which are permeable to an ultrafiltration membrane having a pore diameter in the range of about 1,000 to about 50,000 and preferably about 5,000 to about 25,000 Daltons.

The animal feed additive according to the invention is characterized by the fact that it is either free of lactose or has only a low lactose content. The main aim here is to prevent the formation of crystals in the product, as this has a negative impact on product quality.

In a preferred embodiment, the lactose content is less than 0.1 wt.-percent, based on the total weight of the animal feed additive according to the invention, preferably less than 0.01 wt.-percent.

In a preferred embodiment, the animal feed additive according to the invention has a pH value which is in the range from about 4.5 to about 5.5, preferably in the range from about 4.7 to about 5.0. It has been found that a pH value of 3.9 is particularly advantageous for the microbiological properties of the animal feed additive according to the invention. Accordingly, in a particularly preferred embodiment, the animal feed additive according to the invention has a pH value of 3.9.

Viscosity plays an important role in the case of handling the animal feed additive for its intended purpose, i.e., for the preparation of animal feed after mixing with dry feed. In this regard, it could be found that a Brookfield viscosity (RVT, spindle 1, 10 rpm) at 20° C. in the range of about 5,000 to about 30,000 mPas is advantageous for handling the animal feed additive according to the invention for the intended purpose. Accordingly, in a preferred embodiment, the Brookfield viscosity (RVT, spindle 1, 10 rpm) at 20° C. of the animal feed additive according to the invention is in the range of about 5,000 to about 20,000 mPas preferably about 6,000 to about 10,000 mPas and more preferably about 7,000 to about 9,000 mPas. These viscosities are reliably achieved by the preparations according to the invention.

The animal feed additive according to the invention has a high Brix value. In a preferred embodiment, the Brix value of the animal feed additive according to the invention is in the range from about 50 to about 90%, preferably in the range from about 65 to about 72%.

### Manufacturing Process

Another object of the present invention relates to a process for preparing the animal feed additive according to the invention, comprising or consisting of the following steps:
(i) Providing a skimmed milk or whey,
(ii) Ultrafiltration of the skim milk or whey from step (a) to obtain a protein-rich and partially mineralized retentate and a permeate depleted in proteins and minerals,
(iii) concentrating the permeate from step (b) to obtain an intermediate product having a dry mass of about 40 to about 60 wt.-percent;
(iv) hydrolysis of the intermediate product from step (c) with the addition of lactase;
(v) concentrating the hydrolyzed intermediate from step (d) to obtain an intermediate having a dry weight of from about 50 to about 80 wt.-percent;
(vi) Adjust the pH value to a value of approx. 4.5 to approx. 5.5.

According to the manufacturing process according to the invention, the starting material (in the sense of the present invention, this can be either skimmed milk or whey) is subjected to ultrafiltration in step (ii), so that a milk protein concentrate (retentate) and a permeate rich in lactose and minerals are obtained.

The term ultrafiltration refers to filtration through membranes with a pore size <0.1 μm. It is a purely physical, i.e., mechanical membrane separation process that works according to the principle of mechanical size exclusion: all particles in the fluids that are larger than the membrane pores are retained by the membrane. The driving force is the differential pressure between the inlet and outlet of the filter surface, which is between 0.1 and 10 bar. Depending on the application, the filter surface can be made of stainless steel, plastic, ceramic or textile fabric. There are various types of filter elements: cartridge filters, flat membranes, spiral wound membranes, pocket filters and hollow fiber modules, all of which are basically suitable in the sense of the present invention.

Ultrafiltration is preferably carried out at temperatures in the range from about 10 to about 55, preferably 10 to 20° C., whereby the membranes preferably have a pore diameter in the range from about 3,000 to about 50,000 and preferably about 5,000 to about 25,000 Daltons. Preferably, these are so-called spiral-wound membranes or plate-frame modules made of polysulfone or polyethylene membranes.

The ultrafiltration is carried out with the addition of slide water or a comparable drinking water quality; in a preferred embodiment, the dilution factor is about 5-15, preferably about 10. The retentate obtained by ultrafiltration is separated off and further utilized in another way. The permeate obtained by ultrafiltration is then concentrated in step (iii) to a dry mass of about 20 to about 40 wt.-percent. This achieves the optimum concentration at which the subsequent lactose hydrolysis takes place optimally. In a preferred embodiment, the permeate of step (b) is concentrated to a dry mass which is in the range from about 25 to about 35 wt.-percent, in particular to a dry mass of about 30 wt.-percent. This dewatering or concentration is preferably carried out in so-called “falling film evaporators”. The concentration is then carried out until the desired dry mass is reached.

In step (iv), the intermediate products containing lactose obtained in step (iii) are subjected to hydrolysis so that lactose is broken down into glucose and galactose; this can lead to partial or complete degradation of the lactose. The enzyme lactase (also known as LPH or LCT) is added to lactose to break it down into the two sugar components. The hydrolysis can be carried out in batches or continuously over a period of about 15 to about 1440 minutes and is preferably carried out in a stirred tank with continuous feed and discharge as well as a dosing device for adding the enzyme and a valve located at the bottom of the reactor for discharging the deactivated enzyme, which sediments over time. It has proven advantageous to use an effective enzyme concentration of about 180,000 to 250,000 FCC units of lactase per kg of lactose to be hydrolyzed. It has also been found advantageous to carry out the reaction at temperatures in the range of about 45 to about 55° C., most preferably at about 50° C. It has also been found advantageous to carry out the reaction at a slightly acidic pH of about 5 to 6. In a first specific embodiment, such an amount of lactase is used in step (iv) that the amount of lactose contained in the intermediate product of step (iii) is completely cleaved into glucose and galactose.

The hydrolyzed intermediate obtained in step (iv) is then concentrated to a dry mass of about 50 to about 80 wt.-percent. In a preferred embodiment, the hydrolyzed intermediate product obtained in step (iv) is concentrated to a dry mass of about 65 to about 75 wt.-percent, in particular to a dry mass of about 70 wt.-percent. This dehydration or concentration takes place, for example, in fluidized bed evaporators, plate evaporators or preferably falling film evaporators.

Subsequently, the pH of the product is adjusted to a value of about 4.5 to about 5.5, namely by adding an organic acid as defined above. In a preferred embodiment, the pH is adjusted to a value of about 4.7 to about 5.0, particularly preferably to 3.9

### INDUSTRIAL APPLICABILITY

Another object of the present invention is the animal feed additive as defined above, obtainable by the method as also defined above.

A further object of the present invention is the use of the animal feed additive according to the invention as a molasses substitute in the production of animal feed.

Another object of the present invention is an animal feed comprising the animal feed additive according to the invention. In a preferred embodiment, the animal feed does not contain molasses.

Another object of the present invention is a process for preparing an animal feed as described above, comprising or consisting of the following steps:
providing an animal feed additive according to the invention, and
mixing a dry feed with the animal feed additive according to the invention.

The choice of dry food is not critical and is determined only by the intended use or taste. All dry feeds (e.g., all commercially available dry feeds) that are suitable for mixing with molasses are suitable for the purposes of the present invention.

### EXAMPLES

### Example 1

100 kg skimmed milk of the following composition:

| SKIMMED MILK | Quantity [% by weight] |
|---|---|
| Lactose | 4.9 |
| Proteins | 3.4 |
| Minerals | 0.8 |
| Glucose | 0.01 |
| Galactose | 0.01 |
| Water | Ad 100 |

was subjected to ultrafiltration at 15° C. using a membrane with a pore size of 15,000 Daltons, whereby a low-protein permeate P1 was obtained as an intermediate product, which had the following composition:

| PERMEAT OF STEP (II) | Quantity [% by weight] |
|---|---|
| Lactose | 5.0 |
| Proteins | 0.2 |
| Minerals | 0.3 |
| Glucose | 0.01 |
| Galactose | 0.01 |
| Water | Ad 100 |

The permeate of step (ii) was then concentrated in a falling film evaporator to obtain an intermediate with a dry mass of about 50 wt. This intermediate had the following composition:

| INTERMEDIATE PRODUCT OF STEP (III) | Quantity [% by weight] |
|---|---|
| Lactose | 45.0 |
| Proteins | 1.9 |
| Minerals | 2.7 |
| Glucose | 0.1 |
| Galactose | 0.1 |
| Water | Ad 100 |

The intermediate product of step (iii) was adjusted to pH =6 in a stirred tank at 50° C. and a quantity of lactase was added such that a concentration of about 200,000 FCC units/kg lactose was obtained. After a hydrolysis time of about 15 hours, a product with the following composition was obtained:

| HYDROLOYSIS PRODUCT OF STEP (IV) | Quantity [% by weight] |
|---|---|
| Lactose | 5.0 |
| Glucose | 20.0 |
| Galactose | 20.0 |
| Proteins | 1, 9, 0 |
| Minerals | 2.7 |
| Water | Ad 100 |

The hydrolysis product of step (iv) was then concentrated in a falling film evaporator to obtain an intermediate product with a dry mass of about 75 wt.-percent. The product of step (v) had the following composition:

| PRODUCT OF STEP (V) | Quantity [% by weight] |
|---|---|
| Lactose | 7 |
| Proteins | 2.8 |
| Minerals | 4.1 |
| Glucose | 30 |
| Galactose | 30 |
| Water | Ad 100 |

The product of step (v) was then adjusted to a pH of 3.9 with lactic acid. The final product (=P1) of the process according to the invention had the following composition:

| ANIMAL FEED ADDITIVE ACCORDING TO THE | Quantity [% by |
|---|---|
| INVENTION | weight] |
| Lactose | 6.8 |
| Proteins | 2.7 |
| Minerals | 3.9 |
| Glucose | 29.0 |
| Galactose | 29.0 |
| Water | Ad 100 |

### Example 2

### Evaluation of P1—Comparison With Molasses

2 different animal feeds (V1 and TF1) were prepared from a commercially available dry feed. In one case, the dry feed was mixed with the amount of molasses recommended by the manufacturer (animal feed V1). For comparison, the dry feed was mixed with the animal feed additive according to the invention in the same amount as the molasses of animal feed V1 (animal feed TF1). Both animal feeds were given to a group of 10 cows. For the first week, the cows were given animal feed V1; the following week they were given animal feed TF1. The feed was administered for the 2 weeks under exactly the same conditions. On the basis of the feed that each animal left, i.e., did not eat, it was found that the animal feed according to the invention was significantly better accepted by the animals, as the data in the following table show:

| | Remaining amount per meal |
|---|---|
| | [% by weight], based on the total |
| PET FOOD | amount of feed given |
| V1 | 10 |
| TF1 | 3 |

What is claimed is:

1. An animal feed additive comprising or consisting of:
(a) glucose;
(b) galactose;
(c) lactose;
(d) minerals derived from milk, preferably from cow's milk;
(e) proteins derived from milk, preferably from cow's milk;
(f) organic acids; and
(g) water,
where component (c) is optional.

2. An animal feed additive according to claim 1, comprising or consisting of:
(a) about 20 to about 40 wt.-percent glucose;
(b) about 20 to about 40 wt.-percent galactose;
(c) 0 to about 40 wt.-percent lactose;
(d) about 1 to about 10 wt.-percent minerals derived from milk;
(d) about 1 to about 10 wt.-percent minerals derived from milk; and
(e) about 1 to about 7 wt.-percent organic acids;
with the proviso that all quantities add up to 100 wt.-percent with water.

3. An animal feed additive according to claim 1, wherein the organic acid is one or more selected from the group consisting of tartaric acid, malic acid, shikimic acid, lactic acid, acetic acid, citric acid, ascorbic acid, formic acid, succinic acid and fumaric acid.

4. The animal feed additive according to claim 1, wherein the lactose content is less than 0.1 wt.-percent.

5. The animal feed additive according to claim 1, wherein the pH value of the animal feed additive is in the range from about 4.5 to about 5.5.

6. The animal feed additive according to claim 1, wherein the Brookfield viscosity (RVT, spindle 1, 10 rpm) at 20° C. of the animal feed additive is in the range from about 5,000 to about 30,000 mPas.

7. The animal feed additive according to claim 1, wherein the Brix value of the animal feed additive is in the range from about 50 to about 90%.

8. A process for preparing the animal feed additive according to claim 1, comprising or consisting of the following steps:
(i) providing a skimmed milk or whey,
(ii) filtering of the skim milk or whey from step (i) to obtain a protein-rich and partially mineralized retentate and a permeate depleted in proteins and minerals,
(iii) concentrating the permeate from step (ii) to obtain an intermediate product having a dry mass of about 40 to about 60 wt.-percent;
(iv) hydrolyzing the intermediate product from step (iii) with the addition of lactase;
(v) concentrating the hydrolyzed intermediate from step (iv) to obtain an intermediate having a dry weight of from about 50 to about 80 wt.-percent; and
(vi) adjusting the pH value to a value of approx. 4.5 to approx. 5.5.

9. The process according to claim 8, wherein filtering is carried out with a membrane having an average pore size of about 1,000 to about 50,000 Daltons.

10. The process according to claim 8, wherein the dry mass of the intermediate product obtained in step (iii) is in the range from about 45 to about 55 wt.-percent.

11. The process according to claim 8, wherein lactase is added to the intermediate product from step (iii) in an amount of 180,000 to 250,000 FCC units per kg of lactose to be hydrolyzed.

12. The process according to claim 8, wherein the dry mass of the intermediate product of step (v) is in the range from about 65 to about 75 wt.-percent.

13. A method comprising adding an animal feed additive of claim 1 to an article of manufacture in place of molasses.

14. Animal feed comprising the animal feed additive according to claim 1.

15. A process for preparing the animal feed according to claim 14 comprising the following steps:
providing the animal feed additive according to claim 1, and
mixing a dry feed with the animal feed additive according to claim 1.
